(19) United States
(12) Patent Application Publication
(10) Pub. No.: US 2023/0120743 A1
(43) Pub. Date: Apr. 20, 2023

(54) LOW FREQUENCY VIBRATION MACHINING CENTER FOR BREAKING UP CHIP

(71) Applicant: Hantop Intelligence Technology Co., LTD., Taichung City (TW)

(72) Inventors: KUAN-WEN CHEN, Taichung City (TW); HAO-TANG WANG, Taichung City (TW)

(73) Assignee: Hantop Intelligence Technology Co., LTD., Taichung City (TW)

(21) Appl. No.: 17/559,801

(22) Filed: Dec. 22, 2021

(30) Foreign Application Priority Data
Oct. 20, 2021 (TW) 110138879

(51) Int. Cl. B23B 23/04; B06B 1/10

(52) U.S. Cl. CPC B23B 23/04; B06B 1/10

(57) ABSTRACT

A low-frequency vibration machining center includes a cam, a transmission shaft, a roller, a tool holder, a driven follower, and an elastic member. An end of the transmission shaft is coaxially connected to the cam, and another end is provided for connecting to a driving device, which is adapted to drive the transmission shaft and the cam to rotate about a first axial direction. The roller is disposed at a position where the roller touches a cam surface of the cam. A second axial direction is defined to be perpendicular to the first axial direction. The roller and the tool holder are disposed at two opposite sides of the driven follower, respectively. The elastic member provides an elastic force to keep the roller being in contact with the cam surface. When the cam is rotated, the roller is pushed to move the driven follower and the tool holder in the second axial direction.

### BACKGROUND OF THE INVENTION

### Technical Field

The present invention relates generally to machining, and more particularly to a low-frequency vibration machining center for breaking up chips, which could be applied during lathe machining.

### Description of Related Art

During conventional machining, a workpiece is fixed to the shaft to be spun at a high speed, and then a tool on the tool holder is moved to touch the workpiece, thereby cutting the workpiece to form the workpiece into a predetermined shape or structure. A great number of chips are formed during the machining process and need to be broken up in time. Otherwise, the precision of cutting and machining can be reduced, the lifetime of the tool can be shortened, and the worktime of machining can be increased. Therefore, the chip management is very crucial during precise machining. However, during the conventional machining, the machining process has to be stopped to clean or break up the chip. Therefore, the worktime of machining is significantly increased, which is not conducive to a high production capacity.

Besides, especially in the field of aircraft manufacturing and precision finishing, the specific materials having high toughness are often used. These kinds of special materials are hard to be processed by the conventional machining center. Besides, the chips of the special materials generated during machining are hard to be broken up. Therefore, the conventional machining center has room for improvement.

### BRIEF SUMMARY OF THE INVENTION

In view of the above, the primary objective of the present invention is to provide a low-frequency vibration machining center that could be applied to the machining of metal, wherein the low-frequency vibration machining center could provide a function of automatic chip-breaking.

The present inventive subject matter provides a low-frequency vibration machining center including a cam, a transmission shaft, a roller, a tool holder, a driven follower, and an elastic member. An end of the transmission shaft is connected to the cam, and another end of the transmission shaft is adapted to be connected to a driving device. The cam and the transmission shaft are coaxial. The driving device is adapted to drive the transmission shaft to rotate about a first axial direction and simultaneously drive the cam to rotate. The roller is disposed at a position where the roller touches a cam surface of the cam. The tool holder is adapted to be connected to a tool. The driven follower is defined to have a second axial direction that is perpendicular to the first axial direction. The roller and the tool holder are disposed at two opposite sides of the driven follower along the second axial direction. The elastic member provides an elastic force to keep the roller being in contact with the cam surface of the cam. When the cam is rotated, the cam could push the roller to drive the driven follower and the tool holder, which is connected to the driven follower, to move back and forth in the second axial direction.

With such a design, the cam is driven by the driving device via the transmission shaft to rotate about the first axial direction, so that the cam could guide the roller, the driven follower, and the tool holder to move back and forth in the second axial direction.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the low-frequency vibration machining center for breaking up chips of an embodiment according to the present invention;

FIG. 2 is a schematic view of the low-frequency vibration machining center of the embodiment according to the present invention, showing the driving device is about to be connected to the machining center;

FIG. 3 is a top view of the low-frequency vibration machining center of the embodiment according to the present invention;

FIG. 4 is a sectional view taken along the 4-4 line in FIG. 3;

FIG. 5 is an enlarged partial view of a marked region A in FIG. 4;

FIG. 6 is a sectional view taken along the 6-6 line in FIG. 3;

FIG. 7 is similar to FIG. 4, showing the interior structure of the low-frequency vibration machining center of another embodiment; and,

FIG. 8 is a top view of the cam of the embodiment according to the present invention.

### DETAILED DESCRIPTION OF THE INVENTION

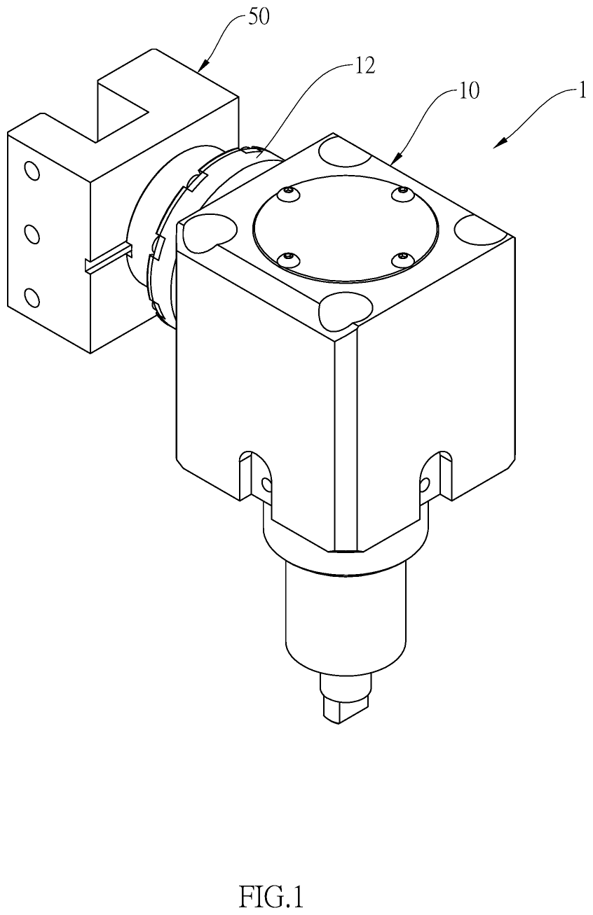

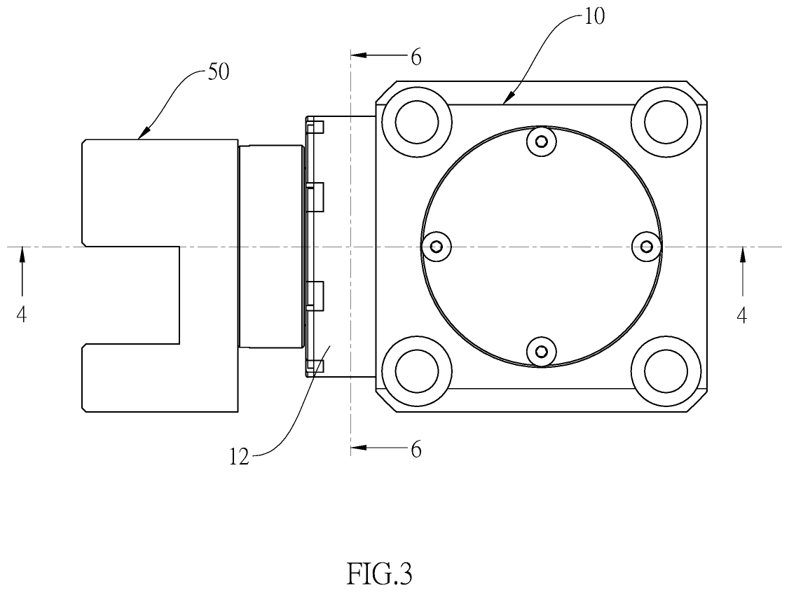

As illustrated in FIG. 1 to FIG. 6, a low-frequency vibration machining center 1 of an embodiment according to the present invention for breaking up chips includes a housing 10, a cam 20, a transmission shaft 30, a roller 40, a tool holder 50, a driven follower, 60, an elastic member 70, a front pressing cover 12, a plurality of gaskets 80, and a restraining member.

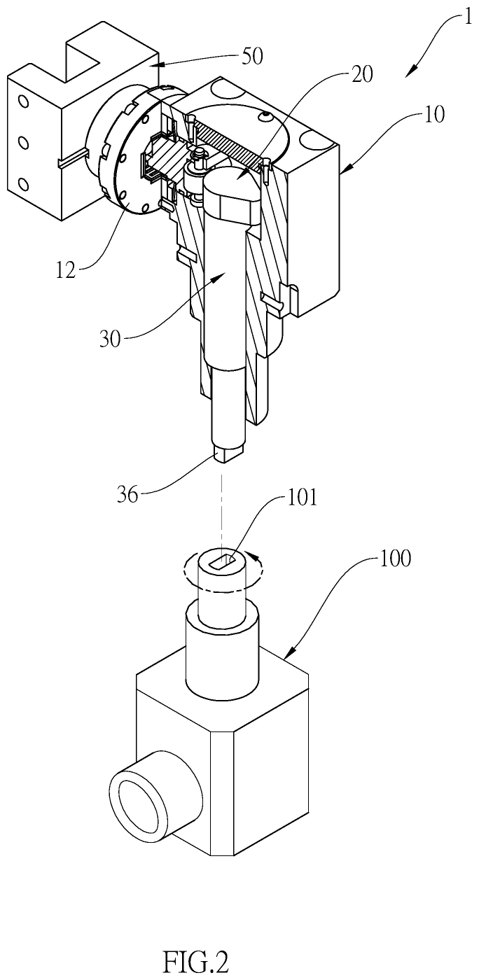

As illustrated in FIG. 2 to FIG. 4, the cam 20, the transmission shaft 30, the roller 40, the driven follower 60, and the elastic member 70 are disposed in a receiving space of the housing 10. The cam 20 is coaxially disposed on the transmission shaft 30. An end of the transmission shaft 30 is connected to the cam 20, another end of the transmission shaft 30 is adapted to be engaged with a driving device 100, wherein the driving device 100 could be a motor or a turret. A first axial direction Y and a second axial direction X are defined to be perpendicular to each other. Along the first axial direction Y, the first axial direction Y has a first section 32, a second section 34, and a connecting section 36, wherein the cam 20, the first section 32, the second section 34, and the connecting section 36 are connected sequentially. An outer diameter of the first section 32 is greater than an outer diameter of the second section 34. As illustrated in FIG. 2, the connecting section 36 is inserted through an opening of a bottom of the housing 10 and is provided for engaging with a recess 101 of the driving device 100 by inserting. A contour of the connecting section 36 is non-circular. A shape of the recess 101 complementarily corresponds to the contour of the connecting section 36.

Therefore, the driving device 100 could drive the transmission shaft 30 to rotate about the first axial direction Y and simultaneously drive the cam 20 to rotate concentrically. In the current embodiment, the contour of the connecting section 36 is rectangular, and the recess 101 of the driving device 100 is rectangular as well. Practically, the contour of the connecting section and the recess of the driving device could be in other shapes, as long as the transmission shaft could be driven to rotate about the first axial direction.

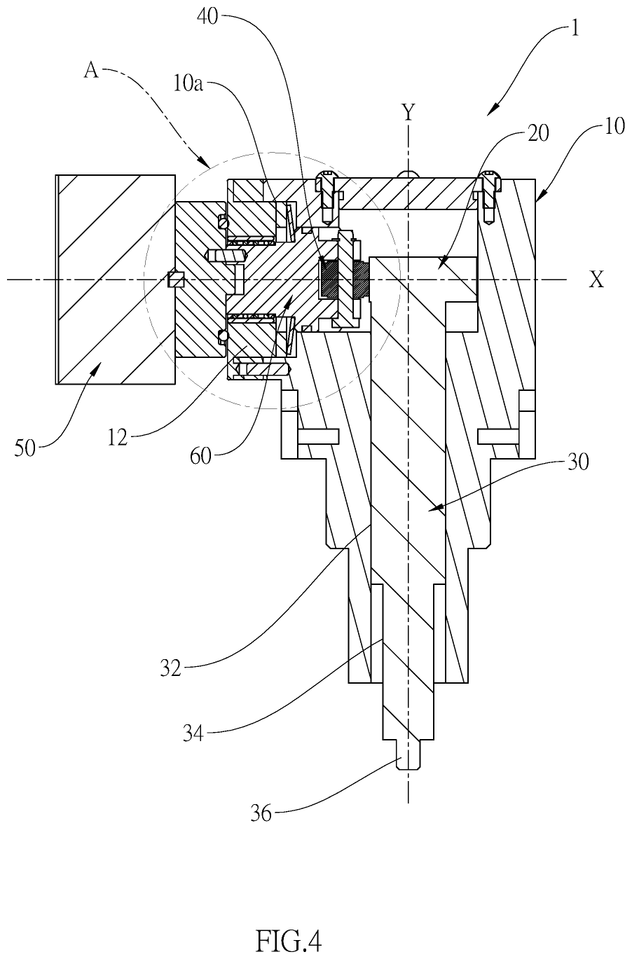

As illustrated in FIG. 4, the cam 20, the roller 40, the driven follower 60, and the tool holder 50 are sequentially arranged along the second axial direction X. The roller 40 is a cylinder roller. The roller 40 and the tool holder 50 are located at and connected to two opposite sides of the driven follower 60 along the second axial direction X, respectively. The driven follower 60 has a receiving groove 62 at a side that faces the roller 40, wherein the roller 40 is disposed in the receiving groove 62. The roller 40 has an axial hole. A screw rod 42 passing through the axial hole of the roller 40 is pivotably fixed on the driven follower 60, wherein the screw rod 42 has a longitudinal axis that extends along a direction parallel to the first axial direction Y. With such a design, the roller 40 could roll about the longitudinal axis.

As illustrated in FIG. 4, a side of the housing 10 has an opening 10a, wherein the front pressing cover 12 is disposed at the opening 10a of the housing 10, an outer periphery of the driven follower 60 has a shoulder 601 extending outwardly from the outer periphery of the driven follower 60. An end of the elastic member 70 abuts against the shoulder 601, and another end of the elastic member 70 abuts against the front pressing cover 12. A side of the front pressing cover 12 is disposed with the tool holder 50 which is adapted to be engaged with a tool. With such a design, the elastic member 70 could provide an elastic force to allow the roller 40 to be in a position where the roller 40 touches a cam surface of the cam 20. In other words, when the cam 20 is driven by the driving device 100 via the transmission shaft 30 to rotate about the first axial direction Y, the cam 20 could guide the roller 40, the driven follower 60, and the tool holder 50 by the cam surface of the cam 20, to move back and forth along the second axial direction X, so that the tool disposed on the tool holder 50 to generate a low-frequency vibration in the second axial direction X, thereby achieving a purpose of automatically chip breaking which could be applied to machining. A frequency of the low-frequency vibration is in a range of 0 to 200 Hz.

More specifically, in the exemplary current embodiment, the elastic member 70 is a disc spring. However, the elastic member 70 could be other kinds of commercially available springs. Additionally, depending on the characteristics and properties of each of workpieces, the elastic member 70 could include a plurality of elastic members in parallel or series.

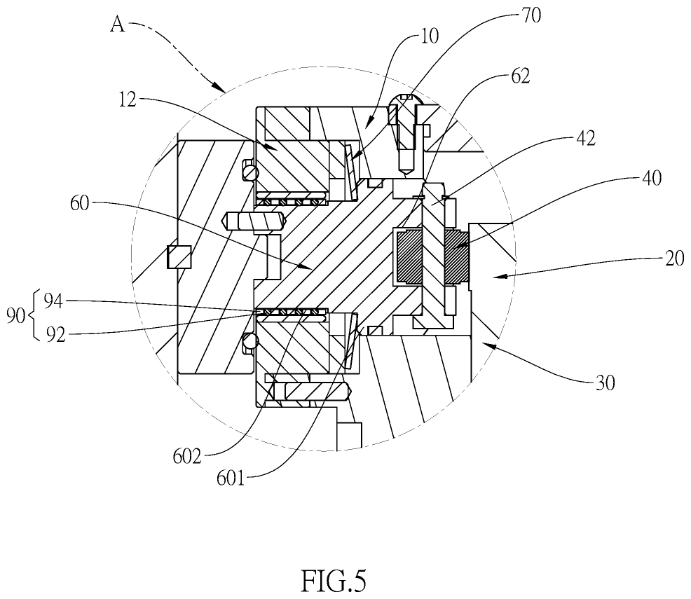

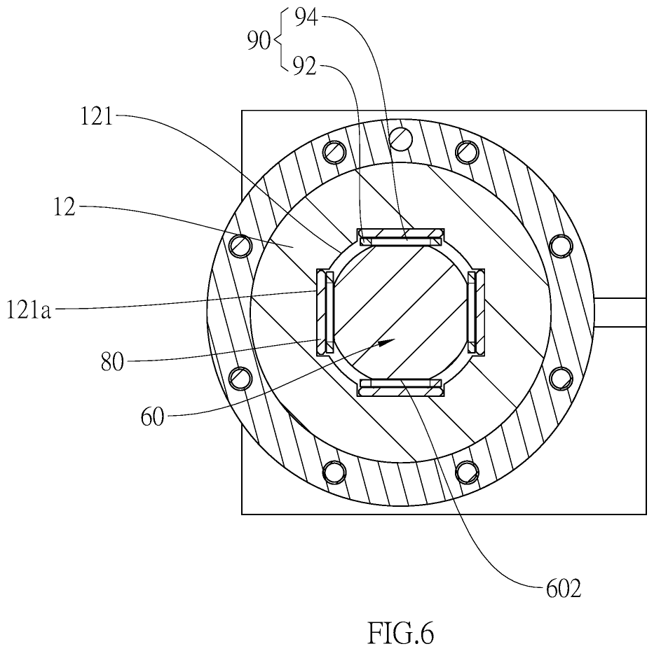

As illustrated in FIG. 5 and FIG. 6, the low-frequency vibration machining center 1 further includes a plurality of gaskets 80. The front pressing cover 12 has a through hole 121, wherein an end of the driven follower 60 passes through the through hole 121 and is connected to the tool holder 50. The restraining member is disposed between a wall of the through hole 121 and a circumference of the driven follower 60 to prevent the driven follower 60 from rotating about the second axial direction X relative to the housing 10 and the front pressing cover 12. The wall of the through hole 121 has a plurality of grooves 121a, wherein each of the gaskets 80 is correspondingly disposed in one of the grooves 121a. The circumference of the driven follower 60 has a plurality of flat surfaces 602 which are evenly spaced in a circumferential direction of the driven follower 60. The restraining member includes a plurality of linear bearings 90, wherein each of the linear bearings 90 is disposed at a position corresponding to one of the flat surfaces 602 and is located between the wall of the through hole 121 and the circumference of the driven follower 60. Each of the gaskets 80 is located between one of the linear bearings 90 and the corresponding one of bottoms of the grooves 121a. Each of the linear bearings 90 includes a retainer 92 and a plurality of needle rollers 94, wherein the needle rollers 94 are pivotably disposed in the retainer 92 and could merely be rolled in the second axial direction X.

With such a design, the restraining member could restrict the driven follower 60 to merely move back and forth second axial direction X. In the current embodiment, the flat surfaces 602 are evenly spaced around the circumference of the driven follower 60 in the circumferential direction, and a number of the flat surfaces 602 of the circumference of the driven follower 60 is four as an example. In other embodiments, a number of the flat surfaces on the circumference of the driven follower could be three or more than four, and the flat surfaces are evenly spaced in the circumferential direction of the driven follower. Simultaneously, a number of the grooves, a number of the gaskets, and a number of the linear bearings correspond to the number of the flat surfaces on the circumference of the driven follower. Similarly, the driven follower 60 could be restricted to merely moving back and forth in the second axial direction X.

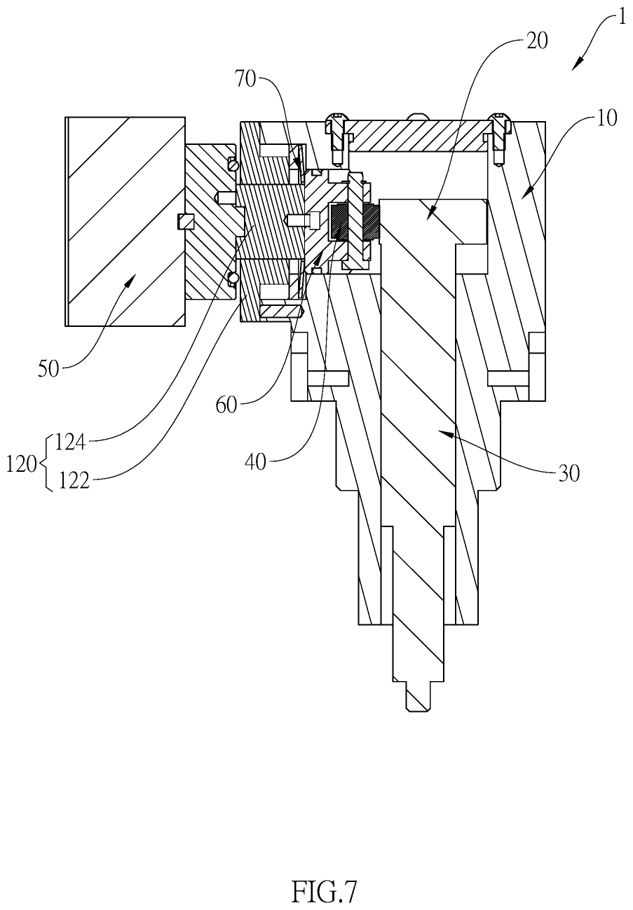

Furthermore, in the current embodiment, the restraining member is a plurality of linear bearings 90 as an example. In other embodiments, the restraining member could be a ball spline 120 as shown in FIG. 7, wherein the ball spline 120 is disposed at the opening 10a of the housing 10. The ball spline 120 includes an external cylinder 122, a spline shaft 124, and a plurality of balls. The external cylinder 122 is connected to the housing 10 and fits around the spline shaft 124. An outer wall of the spline shaft 124 is disposed with a plurality of slots extending along the second axial direction X, wherein the balls are disposed in the slots, and the driven follower 60 is connected to the tool holder 50 via the spline shaft 124. The two ends of the elastic member 70 abut against the driven follower 60 and the external cylinder 122, respectively. With such design, the spline shaft 124 could be linearly moved back and forth in the second axial direction X relative to the external cylinder 122. In other words, the ball spline 120 could restrict the driven follower 60 to move linearly in the second axial direction X.

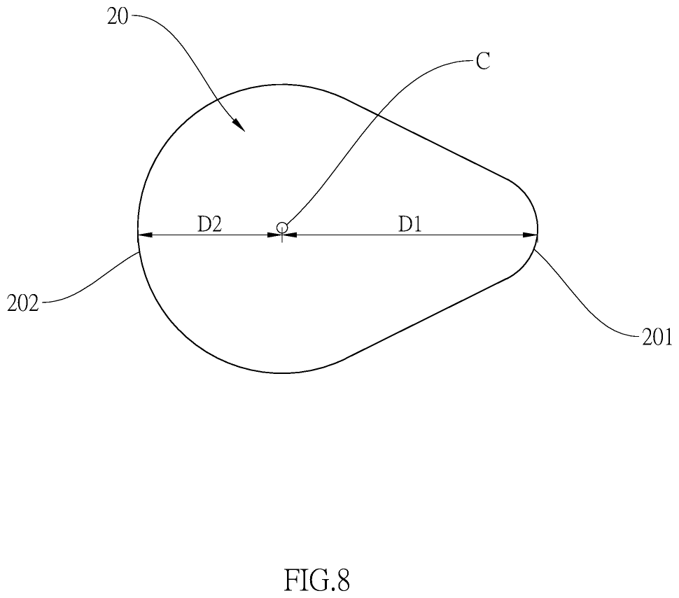

As illustrated in FIG. 8, a top view of the cam 20 is shown. The contour of the cam 20 has a first curved section 201 and a second curved section 202 that are connected to each other. A maximum distance D1 is defined as a greatest distance between the first curved section 201 and a center C of the cam 20, and a minimum distance D2 is defined as a greatest distance between the second curved section 202 and the center C of the cam 20, wherein a difference between the maximum distance D1 and the minimum distance D2 is in a range of 0.1-2 mm. In another embodiment, a number of the first curved section and the second curved section could be more than one, wherein the first curved sections and the second curved sections are staggered with respect to each other.

With a such design, the cam 20 of the low-frequency vibration machining center 1 of the current embodiment according to the present invention could be driven by the driving device 100 to rotate about the first axial direction Y via the transmission shaft 30, so that roller 40, the driven follower 60, and the tool holder 50 could be guided by the cam surface of the cam 20 to move back and forth in the second axial direction X. Thus, the tool disposed on the tool holder 50 could vibrate at the low-frequency to break up the chip generated during the operation of the machining center, thereby promoting the production efficiency and prolonging the life of the tool.

It is pointed out that the embodiment described above is only a preferred embodiment of the present invention. All equivalent structures which employ the concepts disclosed in this specification and the appended claims should fall within the scope of the present invention.

What is claimed is:

1. A low-frequency vibration machining center, comprising:
a cam;
a transmission shaft, wherein an end of the transmission shaft is connected to the cam, and another end of the transmission shaft is adapted to be connected to a driving device; the cam and the transmission shaft are coaxial; the driving device is adapted to drive the transmission shaft to rotate about a first axial direction and simultaneously drive the cam to rotate;
a roller disposed at a position where the roller touches a cam surface of the cam;
a tool holder adapted to be connected to a tool;
a driven follower defined to have a second axial direction that is perpendicular to the first axial direction; the roller and the tool holder are respectively disposed at two opposite sides of the driven follower along the second axial direction;
an elastic member providing an elastic force to allow the roller to keep in contact with the cam surface of the cam;
wherein when the cam is rotated, the cam pushes the roller to drive the driven follower and the tool holder, which is connected to the driven follower to move back and forth in the second axial direction.

2. The low-frequency vibration machining center as claimed in claim 1, wherein the cam surface of the cam has at least one first curved section and at least one second curved section; the at least one first curved section; a maximum distance is defined as a greatest distance between the first curved section and a center of the cam, and a minimum distance is defined as a greatest distance between the second curved section and the center of the cam.

3. The low-frequency vibration machining center as claimed in claim 2, wherein a difference between the maximum distance and the minimum distance is in a range of 0.1-2 mm.

4. The low-frequency vibration machining center as claimed in claim 2, wherein the at least one of first curved sections comprises a plurality of first curved sections, and the at least one of second curved sections comprises a plurality of second curved sections; the plurality of first curved sections and the plurality of second curved sections are staggered with respect to each other.

5. The low-frequency vibration machining center as claimed in claim 1, comprising a housing, a front pressing cover, and a restraining member, wherein the cam, the transmission shaft, the roller, the driven follower, and the elastic member are disposed in the housing; the housing has an opening; the front pressing cover is disposed at the opening of the housing; the front pressing cover has a through hole; an end of the driven follower passes through the through hole and is connected to the tool holder; the restraining member is disposed between a wall of the through hole and a circumference of the driven follower to prevent the driven follower from rotating relative to the housing and the front pressing cover about the second axial direction.

6. The low-frequency vibration machining center as claimed in claim 5, wherein the circumference of the driven follower has a plurality of flat surfaces which are arranged along a circumferential direction of the driven follower; the restraining member comprises a plurality of linear bearings; each of the linear bearings is disposed at a position corresponding to one of the plurality of flat surfaces and is located between the wall of the through hole and the circumference of the driven follower.

7. The low-frequency vibration machining center as claimed in claim 6, comprising a plurality of gaskets, wherein the wall of the through hole has a plurality of grooves; each of the gaskets is correspondingly disposed in one of the grooves and is located between the one of the linear bearings and the corresponding one of bottoms of the grooves.

8. The low-frequency vibration machining center as claimed in claim 5, wherein an outer periphery of the driven follower has a shoulder extending outwardly from the outer periphery of the driven follower; an end of the elastic member abuts against the shoulder, and another end of the elastic member abuts against the front pressing cover.

9. The low-frequency vibration machining center as claimed in claim 1, comprising a ball spline and a housing, wherein the cam, the transmission shaft, the roller, the driven follower, and the elastic member are disposed in the housing; the housing has an opening; the ball spline is disposed at the opening of the housing; the ball spline comprises a spline shaft, wherein the driven follower connected to the tool holder via the spline shaft.

10. The low-frequency vibration machining center as claimed in claim 1, wherein the transmission shaft has a first section, a second section, and a connecting section along the first axial direction, and the cam, the first section, the second section, and the connecting section are connected sequentially; an outer diameter of the first section is greater than an outer diameter of the second section; the connecting section is adapted to be engaged with a recess of the driving device; a contour of the connecting section corresponds to a shape of the recess and is non-circular.
